(19) United States
(12) Patent Application Publication
(10) Pub. No.: US 2002/0085895 A1
(43) Pub. Date: Jul. 4, 2002

(54) Blind rivet for structural elements with different wall thicknesses, and method of producing the blind rivet

(76) Inventor: Klaus Dehlke, Windsbach (DE)

Correspondence Address: LERNER AND GREENBERG, P.A., 2445 Hollywood Boulevard, Hollywood, FL, 33020, US

(21) Appl. No.: 10/011,132

(22) Filed: Nov. 13, 2001

Related U.S. Application Data
(63) Continuation of application No. PCT/EP00/04143, filed on May 10, 2000.

(30) Foreign Application Priority Data
May 11, 1999 (DE) 199 21 548.0
Jul. 2, 1999 (DE) 199 30 667.2

(51) Int. Cl. F16B 13/04

(52) U.S. Cl. 411/43

(57) ABSTRACT

The blind rivet assembly has a sleeve with a swage head and a sleeve shaft. A mandrel having a head and a shaft is guided through the sleeve. The mandrel shaft is rigid and the sleeve shaft is provided with a deformation region that extends in the longitudinal direction of the sleeve. The deformation region is designed such that a closing head is formed at different longitudinal positions of the deformation area by sleeve folding. The deformation region has continuously decreasing mechanical strength properties in the direction towards the swage head. The blind rivet enables to easily join structural parts of different thicknesses and guarantees at the same time to tear off the mandrel shaft with the swage head in a planar manner.

### CROSS-REFERENCE TO RELATED APPLICATION:

This application is a continuation of copending International Application No. PCT/EP00/04143, filed May 10, 2000, which designated the United States.

### BACKGROUND OF THE INVENTION

Field of the Invention

The present invention relates to a blind rivet with a sleeve including a sleeve shank and a preformed set head, and a mandrel including a head and a mandrel shank, which is guided through the sleeve. The invention also relates to a method for producing such a blind rivet.

That type of blind rivet is often constructed as a so-called breakable-stem blind rivet, wherein the mandrel breaks off at a predetermined break point in the riveting process. In the riveting process, the parts that are being joined are typically clamped between the preformed set head and what is known as a blind head. The latter is usually formed by a process of shaping the sleeve shank in the riveting process. The shaping process is effectuated in that a tensile force is exerted on the mandrel, as a result of which the mandrel head, which is disposed opposite the preformed set head, exerts a deforming force on the sleeve shank.

For a number of individual instances, in such a breakable-stem blind rivet a flush termination of the residual part of the mandrel remaining in the sleeve relative to the preformed set head is desired. Such a plane fracture has advantages with respect to the requirements for the bearing behavior characteristic, optics, and resistance to corrosion of the blind rivet joint.

U.S. Pat. No. 5,213,460 (European patent EP 0 527 581 B1) describes a breakable-stem blind rivet. Two different shaping processes for forming a blind head can be derived from that document. In the first instance, two separate sleeve parts are situated opposite the preformed set head, the first part being moved over the second part by means of the mandrel head, so that the first sleeve part is swaged, producing a blind head, and abuts the structural element being joined at its face side. The outside diameter of the mandrel head is equal to that of the first sleeve part. In an alternative development, the sleeve for forming the blind head is constructed in one piece and includes a deformation region which is folded in the riveting process, giving rise to an annular collar in a predetermined position. Here also the outside diameter of the mandrel head is equal to that of the sleeve. In both cases, the blind head is always formed at the same longitudinal position of the sleeve, so that the spacing between the preformed set head and the blind head is fixed. The known blind rivet is thus designed only for a constant clamp region, i.e. for a predetermined thickness of the structural elements being joined. The blind rivet must therefore be laid out specifically according to the respectively intended instance of application.

In order to improve the utility of a blind rivet, it is desirable to be able to join structural elements of different thicknesses using the blind rivet; that is, to be able to realize clamp regions of different sizes with the blind rivet. This minimizes the cost of stockkeeping and eliminates the risk of mistakes in processing the same blind rivets with different clamp regions. But the problem often arises therein that, in a breakable-stem blind rivet, a plane fracture, i.e. the flush termination of the residual mandrel with the preformed set head, is impossible owing to the different clamp regions.

German patent DE 28 21 356 C2 describes a breakable-stem blind rivet wherein the blind head is formed by moving two sleeve parts over one another. In order to achieve a flush termination of the residual mandrel with the preformed set head, a deformation region for forming a collar by folding the sleeve is additionally provided. This folding ability of the sleeve makes possible a plane fracture. The disadvantage of this embodiment is that, besides the blind head, an additional deformation region must be provided in the sleeve shank.

U.S. Pat. No. 4,405,273 (German patent DE 28 29 984 C2) describes an alternative development of a breakable-stem blind rivet with the ability to execute a plane fracture in various clamp regions. In the breakable-stem blind rivet therein, the mandrel head has several teeth surrounding it in a ring shape. The mandrel head is pulled into the sleeve shank in the riveting process and thereby bent outward, forming a blind head. The length compensation for different clamp regions is achieved in that a certain number of teeth, depending on the thickness of the structural element, snap off inside the sleeve, so that the mandrel shank is pulled deeper into the sleeve in thinner structural elements. The mandrel head is then ultimately formed by the remaining annular teeth. The disadvantage of this embodiment is that it requires a shaping process both in the sleeve and in the mandrel head. In addition, a relatively complex geometry of the mandrel head is required, which is expensive to produce.

### SUMMARY OF THE INVENTION

It is accordingly an object of the invention to provide a blind rivet fastener for structural parts having different wall thicknesses and a corresponding production method, which overcomes the above-mentioned disadvantages of the heretofore-known devices and methods of this general type and which provides for an optimally simply designed blind rivet with which different clamp regions can be realized. A further object of the invention is to lay out a method for producing such a blind rivet.

With the foregoing and other objects in view there is provided, in accordance with the invention, a blind rivet assembly, comprising:

is a sleeve formed with a preformed set head and a sleeve shank; and

a mandrel extending through said sleeve, said mandrel including a mandrel head and a shank;

said sleeve shank being formed with a deformation region extending in a longitudinal direction of said sleeve and being defined with a constantly varying strength of said sleeve shank, whereby a blind head can be formed at different longitudinal positions of said deformation region upon a creasing of said sleeve.

In other words, the objects of the invention are achieved with a blind rivet having a sleeve comprising a preformed set head and a sleeve shank, and with a mandrel leading through the sleeve which comprises a mandrel head and mandrel shank. The mandrel is non-deformable and rigid, but the sleeve shank is formed with a deformation region that extends in the longitudinal direction of the sleeve. The deformation region has a continuously decreasing strength, so that a blind head is formable at different longitudinal positions of the deformation region by the creasing of the sleeve.

Because the deformation region is specifically constructed with the possibility of different blind head positions, different clamp regions can be realized, so that structural elements of different thicknesses can be joined. At the same time, only a single shaping process along the lines of a creasing of the sleeve is required for the length compensation. In particular, the undeformability of the mandrel head is advantageous for a simple construction. An intensive deforming of the mandrel head is unnecessary.

In accordance with an added feature of the invention, the blind rivet is implemented in that the path traveled by the mandrel in the riveting process is substantially independent of the position of the blind head that is formed, i.e., independent of the thickness of the structural element. A plane fracture at a predetermined predetermined fracture groove can therefore be easily realized. At the end of the riveting process, the total length of the set rivet, from the preformed set head to the mandrel head, is always constant, regardless of the thickness of the structural element. Only the position of the blind head is different depending on the thickness of the structural element. This type of blind rivet in the style of a breakable-stem blind rivet is suitable for realizing different clamp regions and at the same time guarantees a plane-parallel shearing of the mandrel shank relative to the preformed set head of the sleeve.

The mandrel head preferably includes a stop for this purpose, which is pressed against a counterstop in the riveting process, whereupon the force exerted on the mandrel abruptly rises and gives rise to a shearing of the mandrel shank at the predetermined fracture groove.

In order to make possible a simple construction, the counterstop is preferably formed at the sleeve.

The stop is preferably formed by a reduction of the outside diameter of the mandrel shank, and the counterstop is formed by a corresponding reduction of the inside diameter of the sleeve. The sleeve typically includes a borehole through which the mandrel shank is led. This borehole thus has an offset which comes in contact with the stop of the mandrel shank. This stop is preferably formed in the region of the preformed set head.

As an alternative to arranging the counterstop at the sleeve, it is provided at a setting tool for the blind rivet. This obviates the need for an offset in the borehole.

In accordance with another feature of the invention, the sleeve and the mandrel are each constructed in one piece. The geometry is therefore easy to realize from a production standpoint.

According to a particularly expedient development, the deformation region includes regions with varied strengths. These varied strength regions guarantee, in a particularly efficient and simple fashion, the forming of the blind head directly at the structural element being riveted. In particular, this inventive development easily achieves blind head formation at various longitudinal positions in the deformation region.

The strength of the deformation region advantageously increases proceeding in the direction of the end of the sleeve shank which is averted from the preformed set head. The deformation region thus exhibits the lowest strength in the region near the preformed set head, which is simultaneously the region adjoining the structural element being riveted. The strength increases progressively with the distance from the preformed set head. The advantage of this is that the blind head always forms directly at the structural element being riveted, since the regions of low strength are creased first, forming a blind head. Given thicker structural elements, the deformation region reaches partway into the structural element itself already, so that the region with the lowest strength cannot be deformed. Rather, the region of the deformation region which is located immediately outside the structural element deforms, this having the lowest strength of the residual deformation region remaining outside the structural element.

Preferably, the strength of the deformation region changes continuously. The sleeve thus exhibits a continuous strength gradient. This is particularly easy to realize from a production standpoint.

The varied strengths of the sleeve shank are preferably produced by a region-specific heat treatment (soft annealing) with cooling. The treatment of the deformation region is accomplished partially, it being possible to achieve varied strength values within the deformation region as a function of the interplay of heat treatment and cooling.

As an alternative, the varied strengths are produced by a region-specific strain hardening process. As a rule, the deformation region is first heat-treated and soft annealed in this strain hardening process as well. However, whereas a continuous strength gradient in particular can be generated by the heat treatment and subsequent cooling, both discrete and continuous curves of the strength in the deformation region are achievable with strain hardening.

As a third advantageous alternative for forming the varied strengths, the sleeve comprises varied wall thicknesses. In this case, the strengths are conditioned by the geometry.

In order to guarantee that the blind head is formed only in the deformation region, the regions of the sleeve shank outside the deformation region have a higher strength than this has. The strength there is at least 20% greater than the maximum strength in the deformation region.

In an expedient development, the mandrel head is constructed such that it covers the sleeve shank before and after the riveting process. The mandrel head thus sits on the sleeve shank. No expanding or deformation of the sleeve shank occurs in the region located directly at the mandrel head.

To increase the rivet strength, the mandrel shank is advantageously formed with a lock groove.

According to a second, particularly advantageous embodiment, the object is inventively achieved by a blind rivet with a sleeve including a preformed set head and a sleeve shank, and with a mandrel leading through the sleeve, which comprises a head and a shank, whereby the sleeve shank includes a deformation region extending in the longitudinal direction of the sleeve, which includes regions with varied strengths, so that a blind head can be formed at different longitudinal positions of the deformation region.

The specific advantages and individual features of the above embodiment of the blind rivet are transferable to this embodiment accordingly.

With the above and other objects in view there is also provided, in accordance with the invention, a method of producing a blind rivet, which comprises providing a sleeve with a preformed set head and an adjoining sleeve shank, and fashioning the sleeve shank with a deformation region having a continuously varying strength, such that a blind head is formed, in a riveting process, at a variety of locations along the longitudinal extent of the deformation region.

In other words, a blind rivet has a sleeve which includes a head and an adjoining shank. The shank is provided with a deformation region which serves for forming a blind head in the riveting process. The deformation region is fashioned with regions of varied strengths, so that the blind head can be formed at any of a variety of longitudinal positions within the deformation region.

Other features which are considered as characteristic for the invention are set forth in the appended claims.

Although the invention is illustrated and described herein as embodied in a blind rivet for structural elements with varied wall thicknesses and method for producing such a blind rivet, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS:

FIG. 1 is a partly sectional view of a breakable-stem blind rivet according to the invention in a delivery condition;

FIG. 2 is a sectional view showing a breakable-stem blind rivet in the set condition with a large clamp region;

FIG. 3 is a sectional view showing a breakable-stem blind rivet in the set condition with a small clamp region;

FIG. 4 is a partial section of a breakable-stem blind rivet with a varied wall thickness of the sleeve shank in a deformation region;

FIG. 5 is a similar section of the sleeve shank with a constant wall thickness of the sleeve shank, wherein the varied strengths in the deformation region have been produced by heat treatment and subsequent cooling or by strain hardening;

FIG. 6 is a graph of a schematic curve of the force required for the deformation work, as a function of the length of the shaping region;

FIGS. 7 and 8 are partly sectional and partly elevational views of a breakable-stem blind rivet in the as-received condition prior to the riveting process, and shown together with a setting tool for the riveting process.

Corresponding or identical and functionally equivalent parts are identified with the same reference characters throughout the figures.

### DESCRIPTION OF THE PREFERRED EMBODIMENTS

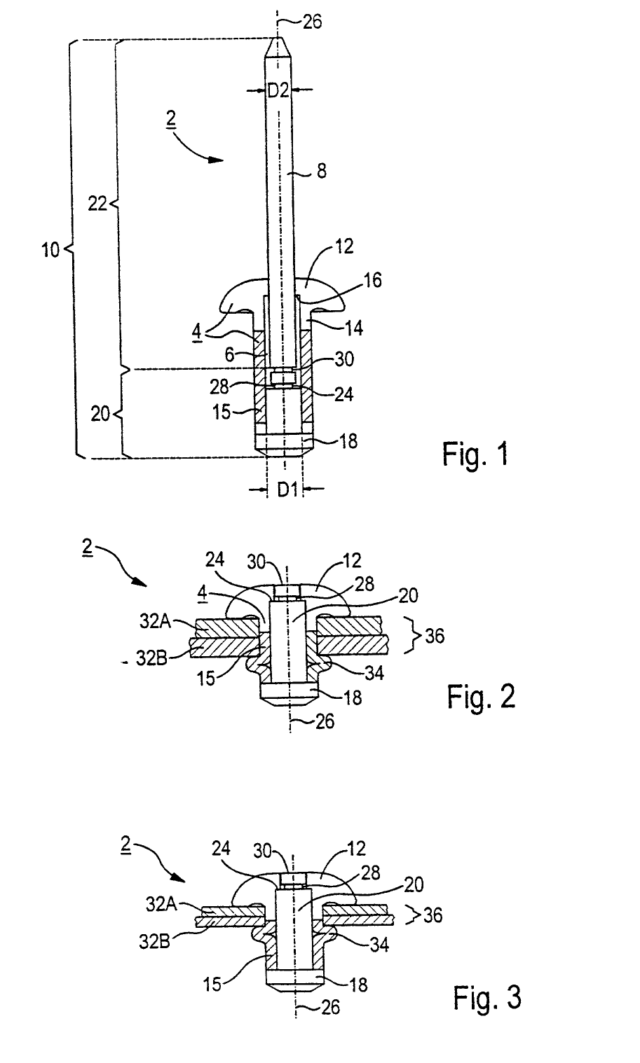

Referring now to the figures of the drawing in detail and first, particularly, to FIG. 1 thereof, the blind rivet 2 includes a sleeve 4 with a borehole 6, through which a shank 8 of a mandrel 10 is guided. The sleeve 4 comprises a preformed set head 12 and an adjoining shank 14. The sleeve shank 14 has an approximately centrally arranged deformation region 15, which is represented by a hatched area in FIG. 1. In the region of the preformed set head 12, the borehole 6 includes an offset, which serves as a counterstop 16.

Besides the shank 8, the mandrel 10 has a head 18 at its terminus, which sits on the end of the sleeve shank 14 and is disposed opposite the preformed set head 12. The mandrel head 18 has the same outside diameter as the sleeve shank 14 and is preferably permanently connected thereto. The mandrel shank 8 is partitioned into a residual shank 20 and a shank region 22. The residual mandrel shank 20 extends from the mandrel head 18 to a predetermined fracture groove 30 and includes a stop 24, which is formed by a reduction of the diameter D1 to a diameter D2 of the mandrel shank 8. Adjoining the stop 24 in the longitudinal direction 26 toward the preformed set head 12, there are formed a lock groove 28 and the predetermined fracture groove 30. The blind rivet 2, accordingly, is constructed as a breakable-stem blind rivet.

The deformation region 15 has different strengths. In particular, the strength progressively increases proceeding from the region of the deformation region adjacent the preformed set head to the region adjacent the mandrel head. The deformation region 15 thus exhibits a continuously increasing strength curve. The force required for shaping the deformation region 15 increases with the strength.

The riveting process will now be described with reference to the FIGS. 1 to 3. In the riveting process wherein two or more structural elements 32A, B are joined, the blind rivet 2 is first inserted into the structural elements 32A, B through the borehole, until the preformed set head 12 sits on the outermost structural element 32A. Next, in order to join the two structural elements 32A, B, a tensile force is exerted on the mandrel shank 8, thereby pressing the mandrel head 18 against the sleeve 4. The exerted force deforms the sleeve in its deformation region 15, and upon the creasing of the sleeve a blind head 34 forms. Because of the different strength values in the deformation region 15, the blind head 34 always emerges immediately at the bottom structural element 32B, regardless of the overall thickness of the two structural elements 32A, 32B, which determines a clamp region 36. The blind head 34 is developed until the stop 24 of the mandrel shank 8 comes in contact with the counterstop 16, whereupon the force exerted on the mandrel shank abruptly rises owing to the tensile stress being placed on it, causing shearing at the predetermined fracture groove 30. The arrangement of the stop 24 and counterstop 16 guarantees, by simple means, that a plane fracture is achieved; that is, the residual mandrel shank 20 terminates plane with the surface of the preformed set head 12. By fashioning the deformation region 15 in such a way that the blind head can form at different longitudinal positions, the ability to join structural elements 32A, B of different thicknesses is simultaneously created.

In comparison with the blind rivets known from the prior art, this type of blind rivet 2 is advantageous in that a flush termination of the residual mandrel 20 at the level of the preformed set head 12 is achieved without an excessively costly shaping mechanism in the forming of the blind head 34 and without a shaping mechanism for the mandrel head 18. The flush termination of the residual mandrel 20 has a positive effect on the bearing behavior characteristics of joints with this type of blind rivet 2 and on the co-bearing effect of the residual mandrel 20 given tensile stress on the sleeve 4. Beyond this, a decisive advantage consists in the ability to expand the clamp region 36 on the basis of the specific design of the deformation region 15. The blind rivet 2 is preferably constructed as what is known as a high-tensile blind rivet. In such high-tensile blind rivets, the length of the clamp region 36 can customarily be varied only 2 mm. This variation of the clamp region 36 is expanded more than 50% to over 3 mm. by the described blind rivet 2. The ability to easily control the blind rivet 2 is particularly advantageous with respect to reliability in joining the structural elements 32A, B. Easy control comes as a result of the path of the mandrel shank 8 to the predetermined fracture being constant and independent of the thickness of the structural element. In any case, the predetermined fracture must occur according to a defined path.

Besides the specific position of the blind head 34, the length compensation given differences in the thickness of structural elements can also be accomplished by a variable height of the blind head. What is meant by a variable blind head height is that the blind head 34 unfolds to a greater or lesser extent. A more extensive unfolding occurs given thinner structural elements, and a less extensive unfolding occurs given thicker structural elements.

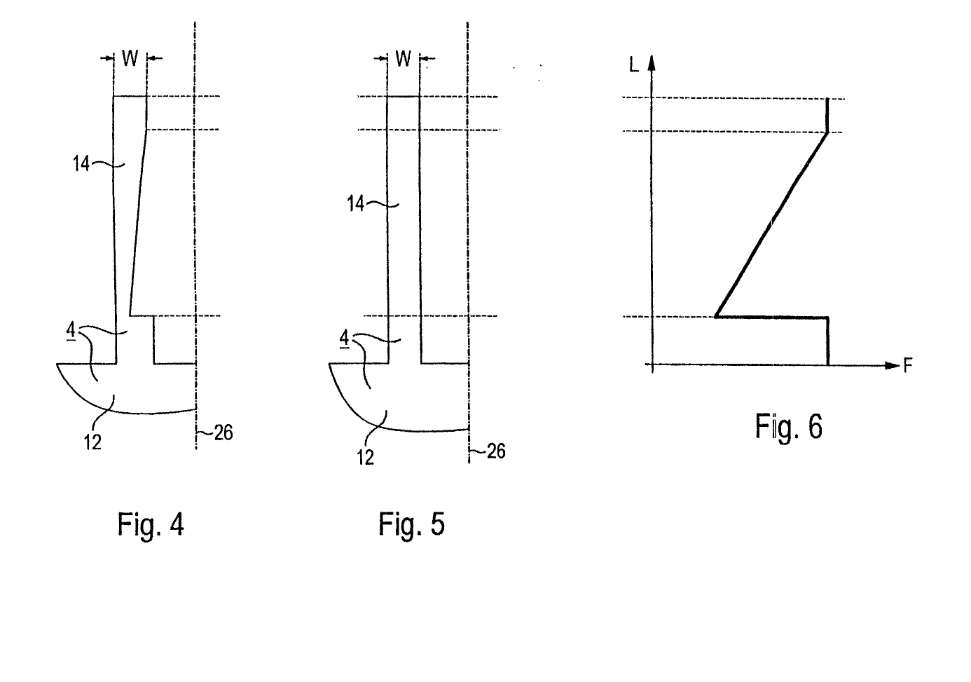

An essential feature with respect to the ability to realize varied clamp regions 36 is that the deformation region 15 has varied strength values. These regions with different strength values within the deformation region 15 can be realized by a geometric scheme, as represented in FIG. 4. Accordingly, the sleeve shank 14 has different wall thicknesses W in the deformation region 15. In particular, the wall thickness W in the deformation region 15 decreases proceeding toward the preformed set head 12.

But the different strength values can also be achieved by a special material treatment given a constant wall thickness W, as represented in FIG. 5. Such a treatment may be a heat treatment with a subsequent cooling process. The individual regions of the deformation region 15 are differently heat-treated and cooled, whereby different strength values are achieved. What is meant by heat treatment is a soft annealing process. Alternatively, the regions can also be hardened differently by cold forging subsequent to a prior soft annealing process.

The object of both the heat treatment with the subsequent cooling process and the strain hardening is a continuous curve of the strength values. But a discrete curve can also occur given strain hardening in particular.

FIG. 6 represents an example of a typical curve for the required shaping force F for forming a blind head 34 as a function of the length L of the mandrel shank 8. The shaping force F is a measure of the strength of the sleeve shank 14. It becomes clear from FIG. 6 that the required shaping force F is at a maximum in the regions of the mandrel shank 8 outside the deformation region 15. Beginning in the region of the deformation region 15 which is remote from the preformed set head, the required shaping force F progressively decreases to a minimum value at the end of the deformation region 15 located in the vicinity of the preformed set head 12, and then abruptly rises to the maximum value again.

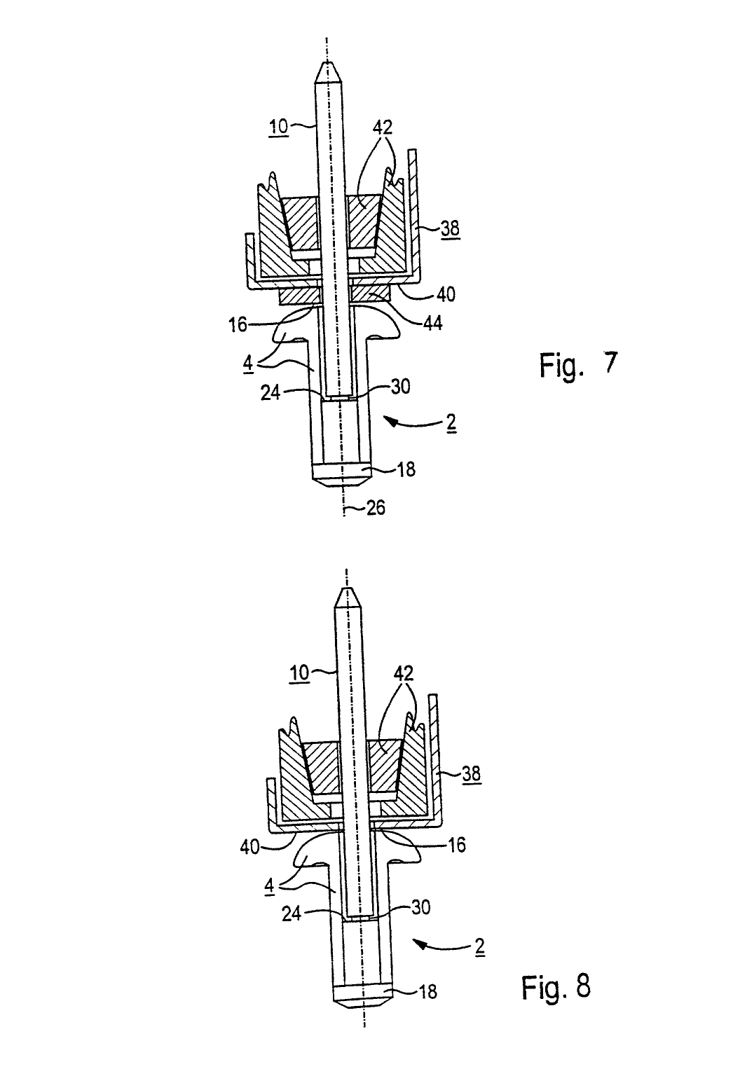

According to FIGS. 7 and 8, a setting tool 38 is provided for carrying out the riveting, which comprises a mouthpiece 40 through which the mandrel shank 8 is led. Elements 42 by means of which the mandrel shank 8 can be grabbed and pulled in the riveting process are provided within the setting tool 38. The blind rivet 2 represented in these figures has a simplified form compared to the blind rivet 2 represented in FIGS. 1 to 3. In fact, the counterstop 16 is no longer provided by the sleeve 4 but rather by the setting tool 38. According to FIG. 7, a special adapter 44 is fashioned as the counterstop 16, whereas in FIG. 8 the mouthpiece 40 is fashioned directly as the counterstop 16. As soon as the stop 24 of the mandrel shank 8 makes contact with the counterstop 16, given that the tensile stress is maintained, this leads to shearing of the mandrel shank 8 at the predetermined fracture groove 30. In this simplified embodiment, the lock groove 28 is not present. As in the embodiment represented in FIGS. 1 to 3, in this blind rivet 2 a plane fracture is guaranteed even in the case of varying clamp regions 36.

I claim:

1. A blind rivet assembly, comprising:
a sleeve formed with a preformed set head and a sleeve shank; and
a mandrel extending through said sleeve, said mandrel including a mandrel head and a shank;
said sleeve shank being formed with a deformation region extending in a longitudinal direction of said sleeve and being defined with a continuously varying strength of said sleeve shank, whereby a blind head can be formed at different longitudinal positions of said deformation region upon a creasing of said sleeve.

2. The blind rivet assembly according to claim 1, wherein the strength of said deformation region increases towards an end of said sleeve shank distal from said preformed set head.

3. The blind rivet assembly according to claim 1, wherein a path traveled by said mandrel in a riveting process is substantially independent of a position of the blind head being formed.

4. The blind rivet assembly according to claim 3, wherein said mandrel shank is formed with a stop, and said stop presses against a counterstop in the riveting process.

5. The blind rivet assembly according to claim 4, wherein the counterstop is formed at said sleeve.

6. The blind rivet assembly according to claim 5, wherein said stop is formed by a reduction of an outer diameter of said shank of said mandrel, and said counterstop is formed by a corresponding reduction of an inner diameter of said sleeve.

7. The blind rivet assembly according to claim 4, wherein the counterstop is formed at a setting tool.

8. The blind rivet assembly according to claim 1, wherein said sleeve and said mandrel are constructed as a single part.

9. The blind rivet assembly according to claim 1, wherein said sleeve shank is formed with varied strengths produced by region-specific heat treatment and cooling.

10. The blind rivet assembly according to claim 1, wherein said sleeve shank is formed with varied strengths produced by region-specific strain hardening.

11. The blind rivet assembly according to claim 1, wherein said sleeve is formed with varied wall thicknesses defining the varied strengths of said sleeve shank.

12. The blind rivet assembly according to claim 1, wherein said sleeve shank has regions outside the deformation region at least 20% stronger than within the deformation region.

13. The blind rivet assembly according to claim 1, wherein said mandrel head is constructed to cover said sleeve shank before and after a riveting process.

14. The blind rivet assembly according to claim 1, wherein said mandrel shank has a lock groove formed therein.

15. A method of producing a blind rivet, which comprises providing a sleeve with a preformed set head and an adjoining sleeve shank, and fashioning the sleeve shank with a deformation region having a continuously varying strength, such that a blind head is formed, in a riveting process, at a variety of locations along the longitudinal extent of the deformation region.

16. The method according to claim 15, which comprises fashioning the deformation region with progressively less strength proceeding in a direction towards the preformed set head.

17. The method according to claim 15, which comprises producing the varying strength of the sleeve shank by region-specific heat treatment and cooling.

18. The method according to claim 15, which comprises producing the varying strength of the sleeve shank by region-specific strain hardening.

19. The method according to claim 15, which comprises producing the varying strength of the sleeve shank by varying a wall thickness of the sleeve.
